(19) United States
(12) Patent Application Publication
(10) Pub. No.: US 2016/0030865 A1
(43) Pub. Date: Feb. 4, 2016

(54) Spherical Contact Ball Joint Style Spool Relief Valve for Filter Applications

(71) Applicant: Mann+Hummel Purolator Filters LLC, Fayetteville, NC (US)

(72) Inventors: Rajan AHUJA, Fayetteville, NC (US); L. Steven CLINE, Fayetteville, NC (US)

(21) Appl. No.: 14/776,417

(22) PCT Filed: Mar. 13, 2014
(86) PCT No.: PCT/US14/26268

§ 371 Date: Sep. 14, 2015

Related U.S. Application Data
(60) Provisional application No. 61/793,850, filed on Mar. 15, 2013.

(51) Int. Cl. B01D 35/147; B23P 15/00; B01D 35/00

(52) U.S. Cl. CPC B01D 35/147; B01D 35/005; B23P 15/001

(57) ABSTRACT

A cartridge forming part of a fluid filter includes a filter element, an end cap overlying one end of the filter element, a central tube having one end secured to the end cap, a biasing element, and a relief valve having a valve piston with a head that is biased by the biasing element into engagement with a valve seat formed by an underside of the end cap. The valve seat is configured so that it has a curvature that is larger than that of the head of the valve piston. In the particular arrangement disclosed, a second end cap overlies another end of the filter element, axially opposite the end cap mentioned, and is also secured to the central tube. Preferably, at least one of the central tube and the valve piston defines a depending pilot for supporting an end of the biasing element.

This application claims priority under 35 U.S.C. §119(e) to U.S. provisional application Ser. No. 61/793,850, filed Mar. 15, 2013, the entire disclosure of which is incorporated herein by reference.

### BACKGROUND OF THE INVENTION

1. Field of the Invention

The present invention concerns an improved cartridge arrangement usable in connection with a type of overall fluid filter or housing that is often referred to as a spin-on type fluid filter or housing.

2. Description of Related Art

Fluid filter designs that are presently available include spin-on or canister sealed fluid filters. These types of filters have components made of metallic or non-metallic materials that support the main function of filtration using a filter element housed inside a can or housing. In such designs, it is common to use relief valves to permit fluid flow in cold conditions, start up conditions, and when filtration media are clogged. Such relief valves open, when necessary, to permit maintaining a flow of oil or other fluid through the overall filter to an engine.

U.S. Pat. No. 8,361,314 to Ahuja et al. discloses a resilient element providing both relief valve and bottom support functions, while U.S. Patent Application Publication 2010/0288688 A1 to Bryson et al., now U.S. Pat. No. 8,480,885, issued July 9, 2013 discloses a fluid filter including a valve element permitting fluid passage through the end cap of a bypass filter element. The disclosures of the Ahuja et al. ('314) patent and the Bryson et al. ('688) publication are incorporated herein by reference in their entireties as non-essential subject matter.

Other documents that may be of interest are U.S. Pat. No. 7,473,355 and U.S. Pat. No. 8,221,619, both to Cline et al., U.S. Pat. No. 7,857,970, U.S. Pat. No. 7,959,804, U.S. Pat. No. 8,152,996, and U.S. Pat. No. 8,157,989, all to Wright et al., and U.S. Pat. No. 8,020,580 to Ahuja et al.

### SUMMARY OF THE INVENTION

In one arrangement according to the present invention, a cartridge forming part of a fluid filter includes a filter element, an end cap overlying one end of the filter element, a central tube having one end secured to the end cap, a biasing element, and a relief valve having a valve piston with a head that is biased by the biasing element into engagement with a valve seat formed by an underside of the end cap. The valve seat is configured so that it has a curvature that is larger than that of the head of the valve piston. In the particular arrangement disclosed, the end cap is a first end cap, and a second end cap overlies another end of the filter element axially opposite the first end cap and is also secured to the central tube. Preferably, at least one of the central tube and the valve piston defines a depending pilot for supporting an end of the biasing element. A process in which a filter or cartridge according to the invention may be assembled is also described.

A relief valve, configured in this way, can be simply made of high quality molded plastic parts, and is suitable for use with oil, fuel, transmission fluid, and other fluid types used in automotive, industrial, chemical, pharmaceutical, and other applications.

### BRIEF DESCRIPTION OF THE DRAWINGS

FIG. 1 is a cross sectional illustration of one embodiment of a fluid filter or filter cartridge having a relief valve arrangement according to the invention.

FIG. 2 illustrates one way in which the filter or cartridge illustrated in

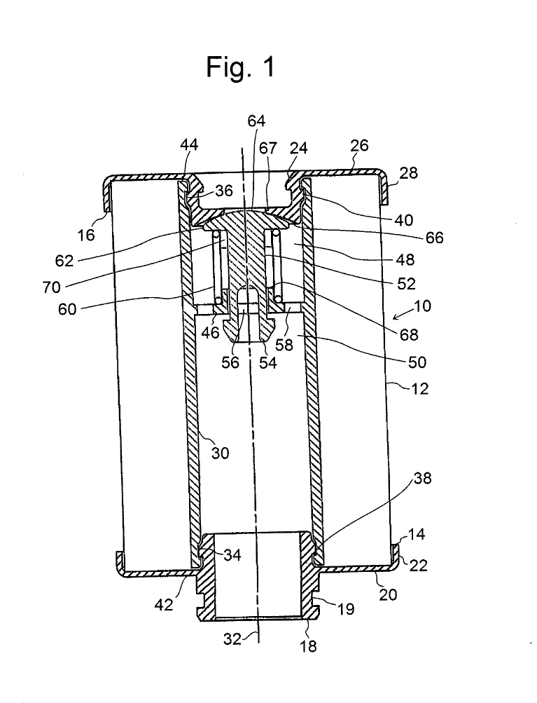

FIG. 1 can be assembled.

FIGS. 3 and 4 illustrate rocking or pivoting of a valve piston relative to a longitudinal filter cartridge axis.

### DETAILED DESCRIPTION OF THE INVENTION

FIG. 1 is a cross sectional illustration of one embodiment of a relief valve arrangement according to the invention when incorporated into a fluid filter element or cartridge 10. The terms “fluid,” “liquid,” and “oil” are used interchangeably here, but it is possible to use the filter cartridge 10 of the invention in connection with fluids or liquids other than oil when desired. It will be understood that the cartridge 10 shown in FIG. 1 is utilized in connection with an overall fluid filter having the filter element or cartridge 10 sealed inside a canister or housing. This type of overall fluid filter or housing is often referred to as a spin-on type fluid filter or housing, and is used, for example, in an automotive or stationary internal combustion engine application requiring uninterrupted oil lubrication for moving parts, with continually filtered oil supplied through the fluid filter in a lubrication circuit.

The cartridge 10 illustrated includes a filter element 12 located between a first end cap 14 and a second end cap 16. The first end cap 14 includes an annular central section 18, a support section 20 extending radially outward from the central section 18, and an upstanding circumferential flange 22 (or multiple flanges, if desired) disposed at the radially outermost portion of the support section 20. The second end cap 16, similarly, includes an annular central section 24, a support section 26 extending radially outward from the central section 24, and an upstanding circumferential flange 28 (or multiple flanges, if desired) disposed at the radially outermost portion of the support section 26.

A porous central tube 30 extends along a longitudinal axis 32 of the filter cartridge 10. In the particular arrangement shown in FIG. 1, the interior surface of the tube 30 has a first circumferential groove 34 adjacent one axial tube end 42 and a second circumferential groove 36 adjacent an opposite axial tube end 44. These circumferential grooves 34 and 36 receive circumferential outer protrusions 38 and 40 on the end cap central sections 18 and 24, respectively, to provide snap fit connections between the central tube 30 and the end caps 14 and 16. If desired, of course, the groove and protrusions could be arranged differently, with grooves located in the cap sections 18 and 24 and protrusions provided on the central tube. Other types of connections between the central tube 30 and the end caps 14 and 16 could be used as well. The central section 18 of the first end cap 14 shown also includes an outwardly opening groove 19 usable to facilitate connection of the cartridge 10 to other fluid filter or mounting structure with which the cartridge is used.

At a selected location between its axial ends, the central tube 30 is provided with a transverse wall 46 dividing the interior volume of the tube 30 into a valve chamber 48 and a fluid discharge chamber 50. In the fully assembled condition shown in FIG. 1, the stem 52 of a valve piston or spool 54 (hereafter referred to as a valve piston) extends through and can reciprocate within a central orifice 56 in the transverse wall 46. An auxiliary fluid passage, or, as shown, a plurality of such auxiliary fluid passages 58, are also provided in the wall 46. Fluid can additionally flow through a clearance (not indicated) disposed between the exterior of the stem 52 and the interior of the orifice 56. As shown, a coil spring or other such biasing element 60 is disposed between the transverse wall 46 and a head 62 of the valve piston 54 to bias an engagement surface 64 of the head 62 into abutment with the valve seat 66, with an open face, formed by an underside of the annular central section 24 of the second end cap 16. The valve piston head 62 and the valve seat 66, together, form a relief valve operating to permit fluid flow around the filter element 12 in certain situations.

The engagement surface 64 and the valve seat 66 are both roughly spherical, but the open seating face provided by the valve seat 66 has a slightly larger curvature or radius than the curvature or radius of the engagement surface 64. As a result, the engagement surface 64 and the valve seat 66 are able to cooperate and provide a constant seal, even when vibrations or other inputs produce fairly extreme rocking of the valve piston 54 relative to the valve seat 66. An upstanding pilot 68, formed by projections or, as illustrated, an annular flange, surrounds the central orifice 56 in the wall 46, while a depending pilot 70, again formed by projections or, as illustrated, an annular collar, surrounds a portion of the valve piston stem 52 adjacent an underside of the valve piston head 62. These pilots help support ends of the spring 60, serve to guide movement of the valve piston 54, help prevent rocking of the valve piston 54, and maintain sealing contact between the engagement surface 64 and the valve seat 66 irrespective of positioning errors.

It will be understood that, in operation, fluid to be filtered primarily passes radially through the filter element 12 from outside to inside, and that the relief valve formed by the piston head 62 and the valve seat 66 permits oil or other fluid to flow around the filter element 12 when the filter element is clogged or the system becomes over-pressurized due to pressure regulator failure or cold temperature start up. Upon displacement of the surface 64 from the valve seat 66 in these conditions, an orifice 67 in the second end cap central section 24 is opened, permitting fluid to pass into the valve chamber 48, through the passages 58 and the clearance between the stem 52 and the orifice 56, into the fluid discharge chamber 50, and out of the fluid filter element or cartridge 10 through the annular central section 18 of the first end cap.

The stiffness of the spring or other biasing element 60 is preferably set so that the relief valve will open at cracking pressures specified to meet the flow requirements at design-specified pressure ratings. The relief valve must also be robust enough not to leak at pressures 60%-70% lower than cracking pressure ratings. Maximum relief valve pressures, moreover, should not increase beyond 50% of ratings with high increases of flow thru the valves. Again, the shapes of the approximately spherical piston head engagement surface and the open, slightly larger radius, approximately spherical seating face exhibited by the valve seat 66, which does not itself prevent flow, provides constant sealing, even under extreme rocking of the valve piston 54.

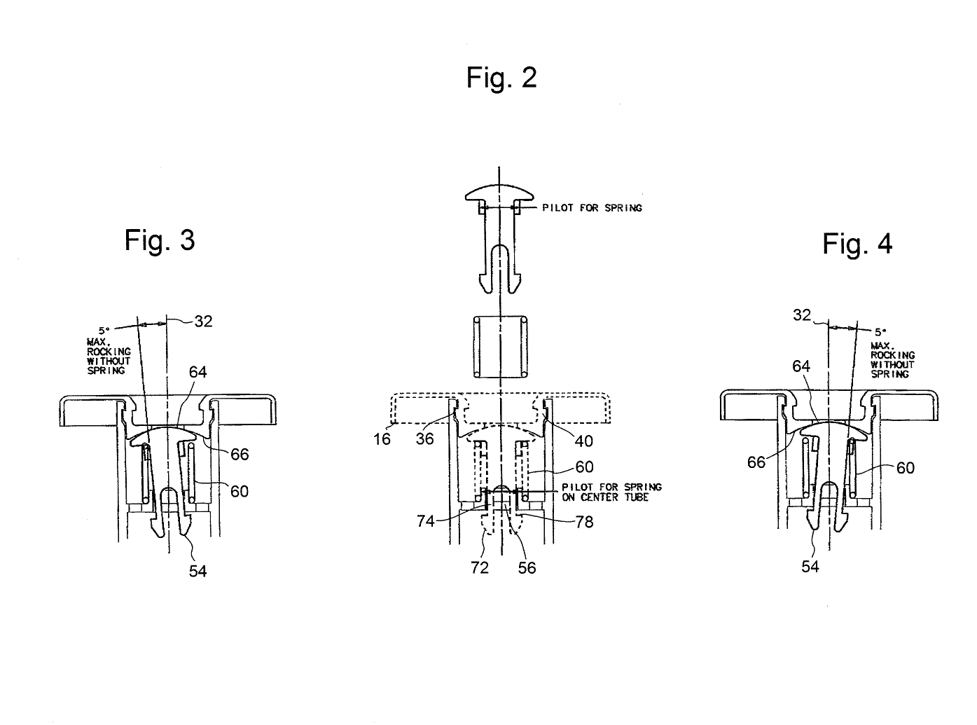

FIG. 2 illustrates one way in which the cartridge 10 illustrated in FIG. 1 can be assembled. Initially, an end of the biasing element 60 is fitted over the upstanding pilot 68 provided on the transverse wall 46 in the central tube 30, and the valve piston stem 52 is inserted through both the biasing element 60 and the central orifice 56 in the transverse wall 46. A beveled surface 72 at the end of each of a plurality of depending legs 74 forming part of the valve piston 54 facilitates deflection of the legs 74 and insertion of the valve piston stem through the orifice 56. Once ends of the legs 74 have passed through the orifice 56 to a sufficient extent, the legs 74 snap back into undeflected positions. The biasing element 60 forces abutment surfaces 78 on the legs 74 to engage an underside of the transverse wall 46 thereby retaining the valve piston 54 in position. By way of the groove 36 and the protrusion 40, the end cap 16 can then be securely fastened in place. As this occurs, contact between the engagement surface 64 and the valve seat 66 displaces the abutment surfaces 78 away from the underside of the transverse wall 46, and into position for use.

FIGS. 3 and 4 illustrate the degree to which the valve piston 54 may rock or pivot relative to the longitudinal filter cartridge axis 32. Use of a biasing element 60 with appropriate stiffness helps to limit rocking or pivoting of the valve piston 54, although the configurations of the cooperating engagement surface 64 and the open seating face provided by the valve seat 66 also helps keep this rocking or pivoting to an acceptable value of at or below about 5° relative to the longitudinal filter cartridge axis 32.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1. A cartridge forming part of a fluid filter comprising:
a filter element,
an end cap overlying one end of the filter element,
a central tube having one end secured to the end cap,
a biasing element, and
a relief valve having a head of a valve piston, the head of the valve piston being biased by the biasing element into engagement with a valve seat formed by an underside of the end cap,
wherein the valve seat has a curvature that is larger than that of the head of the valve piston.

2. The cartridge of claim 1, wherein the end cap is a first end cap, and further comprising a second end cap overlying another end of the filter element axially opposite the first end cap and secured to another end of the central tube.

3. The cartridge of claim 1, wherein at least one of the central tube and the valve piston defines a depending pilot for supporting an end of the biasing element.

4. The cartridge of claim 3, wherein the pilot is defined on the valve piston adjacent the valve piston head.

5. The cartridge of claim 4, wherein the pilot is formed by a flange.

6. The cartridge of claim 5, wherein the flange is annular.

7. The cartridge of claim 3, wherein the pilot is defined on a transverse wall of the central tube adjacent to a central orifice in the transverse wall through which the valve piston extends.

8. The cartridge of claim 7, wherein the pilot is formed by a flange.

9. The cartridge of claim 8, wherein the flange is annular.

10. The cartridge of claim 7, wherein the valve piston includes depending legs including abutment surfaces engageable with the transverse wall to retain the valve piston within the central orifice.

11. The cartridge of claim 4, wherein the pilot defined on the valve piston is a first pilot, and further comprising a second pilot defined on a transverse wall of the central tube adjacent to a central orifice in the transverse wall through which the valve piston extends.

12. The cartridge according to claim 11, wherein the second pilot is formed by a flange.

13. The cartridge according to claim 12, wherein the flange is annular.

14. The cartridge according to claim 1, wherein the valve piston includes depending legs including abutment surfaces engageable with a transverse wall of the central tube.

15. The cartridge according to claim 2, wherein the valve piston includes depending legs including abutment surfaces engageable with a transverse wall of the central tube.

16. The cartridge according to claim 3, wherein the valve piston includes depending legs including abutment surfaces engageable with a transverse wall of the central tube.

17. A process of assembling cartridge components for a fluid filter together, the cartridge including a filter element, an end cap overlying one end of the filter element, a central tube having one end secured to the end cap, a biasing element, and a relief valve having a head of a valve piston, the head of the valve piston being biased by the biasing element into engagement with a valve seat formed by an underside of the end cap that has a curvature that is larger than that of the head of the valve piston, the central tube having a transverse wall through which the valve piston extends that defines a depending pilot for supporting an end of the biasing element, the process comprising:
fitting an end of the biasing element over the depending pilot on the transverse wall,
inserting the valve piston stem through both the biasing element and the central orifice in the transverse wall, and
engaging an underside of the transverse wall with abutment surfaces on legs of the valve piston to retain the valve piston in position within the central tube.

18. The process of claim 17, further comprising:
engaging the underside of the end cap and the head of the valve piston, and
securing the end cap in place on the central tube while displacing the abutment surfaces away from the underside of the transverse wall.

19. The process of claim 17, wherein the end cap acts against a bias of the biasing element as the end cap is secured in place.
